(19) United States
(12) Patent Application Publication
(10) Pub. No.: US 2010/0301144 A1
(43) Pub. Date: Dec. 2, 2010

(54) Low-Flow Faucet Wand

(76) Inventor: William Wray Shepler, North Olmsted, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/475,941

(22) Filed: Jun. 1, 2009

(51) Int. Cl. B05B 1/30

(52) U.S. Cl. 239/569

(57) ABSTRACT

The present invention provides a low-flow wand including a waterway and a flow valve. The waterway includes a flow path. The flow valve is disposed in the flow path. The flow valve is operable to control a rate of fluid flow through the flow path. The flow valve allows a low rate of fluid flow in a default mode and a high rate of fluid flow in an actuated mode.

### FIELD

The present invention relates generally to a faucet wand and, more particularly, to a low-flow faucet wand.

### BACKGROUND

Faucet wands, such as pull-down wands, are often used because they are more versatile than fixed faucets. Faucet wands typically have more than one mode. These modes can include a stream mode, one or more spray modes, and a pause mode. However, these modes do not typically include a low-flow mode and a high-flow mode. Moreover, when these modes include a low-flow mode, some action needs to be taken to actuate the low-flow mode.

### SUMMARY

The present invention provides a low-flow wand. In one embodiment, the wand includes a waterway and a flow valve. The waterway includes a flow path. The flow valve is disposed in the flow path. The flow valve is operable to control a rate of fluid flow through the flow path. The flow valve allows a low rate of fluid flow in a default mode and a high rate of fluid flow in an actuated mode.

In another embodiment, the wand includes a waterway, a spray face, a first valve, and a second valve. The waterway includes an inlet and a plurality of flow paths. The spray face includes a first outlet and a second outlet. The plurality of flow paths includes a first flow path in fluid communication with the inlet, a second flow path in fluid communication with the first flow path and the first outlet, and a third flow path in fluid communication with the first flow path and the second outlet. The first valve is disposed in the first flow path. The first valve is operable to control a rate of fluid flow through the waterway. The second valve is disposed between the first flow path and the second and third flow paths. The second valve is operable to divert fluid flow from the first flow path to the second flow path or the third flow path. The first valve allows a low rate of fluid flow in a default mode and a high rate of fluid flow in an actuated mode.

### BRIEF DESCRIPTION OF THE DRAWINGS

FIG. 1 is a front view of a low-flow faucet wand according to one embodiment of the present invention;

FIG. 2 is an exploded perspective view of the low-flow faucet wand of FIG. 1;

FIG. 3 is a cross-sectional view of the low-flow faucet wand of FIG. 1 along the line A-A; and

FIG. 4 is a cross-sectional view of the low-flow faucet wand of FIG. 1 along the line B-B.

### DETAILED DESCRIPTION

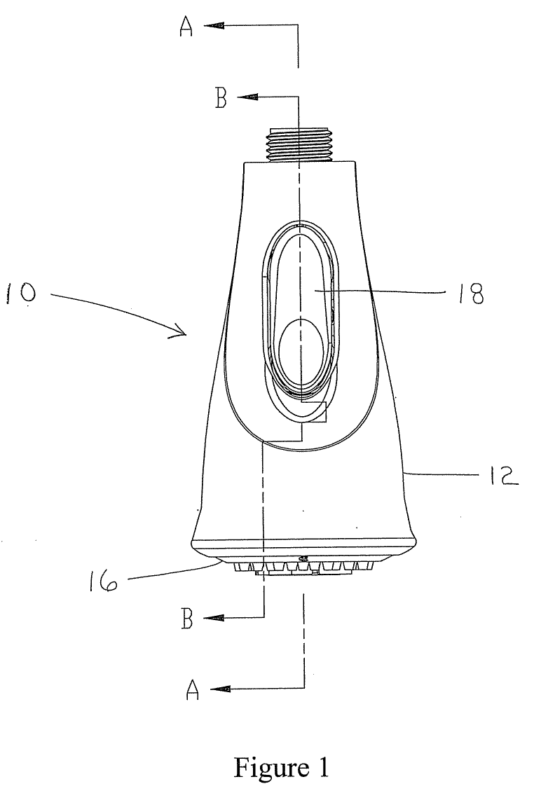

The present invention provides a low-flow faucet wand. One embodiment of a low-flow faucet wand 10 of the present invention is shown in FIGS. 1-4. The wand 10 includes a stream mode and a spray mode. Additionally, the wand includes a low-flow mode and a high-flow mode.

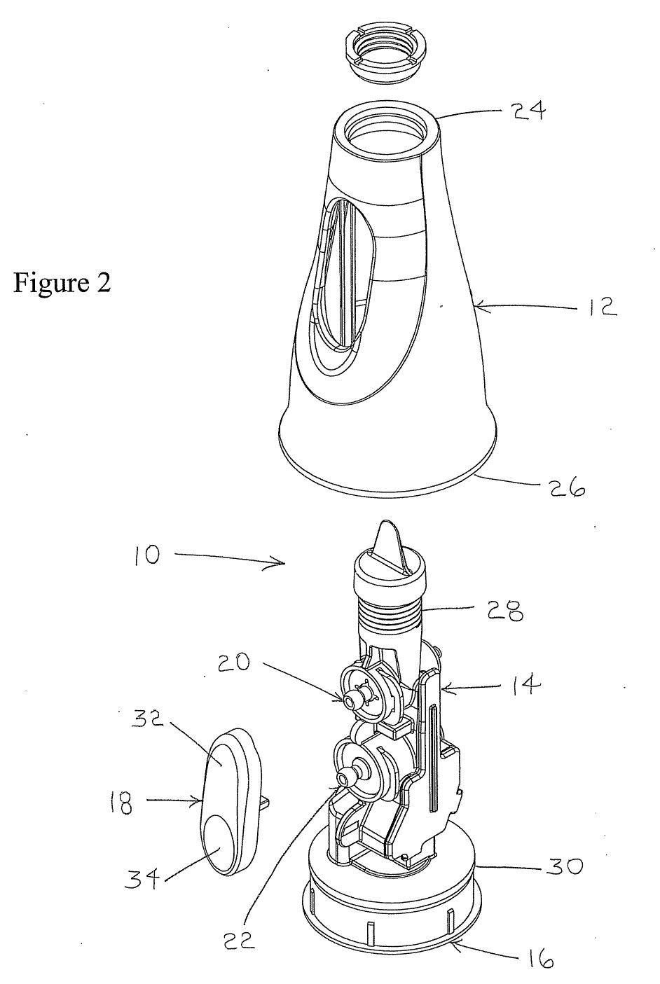

Referring to FIGS. 1 and 2, the wand 10 includes a shell 12, a waterway 14, a spray face 16, a button 18, a first valve 20, and a second valve 22. In the embodiment shown in the Figures, the first valve 20 is a flow valve and the second valve 22 is a diverter valve.

The shell 12 is the outer decorative cover for the wand 10. The shell 12 includes an inlet end 24 and an outlet end 26. The waterway 14 includes various flow paths through and chambers in the wand 10. The waterway 14 includes an inlet end 28 and an outlet end 30. The waterway 14 is disposed in the shell 12 with the inlet end 28 of the waterway 14 generally aligned with the inlet end 24 of the shell 12 and the outlet end 30 of the waterway 14 generally aligned with the outlet end 26 of the shell 12. The spray face 16 is connected to the outlet end 30 of the waterway 14. The spray face 16 is shown connected to the outlet end 30 of the waterway 14 via a threaded connection. However, the spray face 16 could be connected to the outlet end 30 of the waterway 14 via other forms of connection or could be integrally formed with the waterway 14.

The button 18 enables a user of the wand 10 to switch between the various modes of the wand 10. The button 18 includes a first end 32 and a second end 34. The flow valve 20 controls a rate of fluid flow between a low-flow mode and a high-flow mode. The flow valve 20 is actuated by pressing on the first end 32 of the button 18. The diverter valve 22 diverts fluid flow between a stream mode and a spray mode. The diverter valve 22 is actuated by pressing on the second end 34 of the button 18.

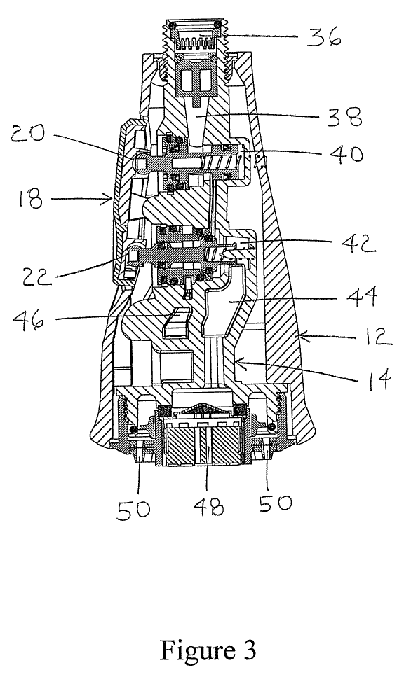

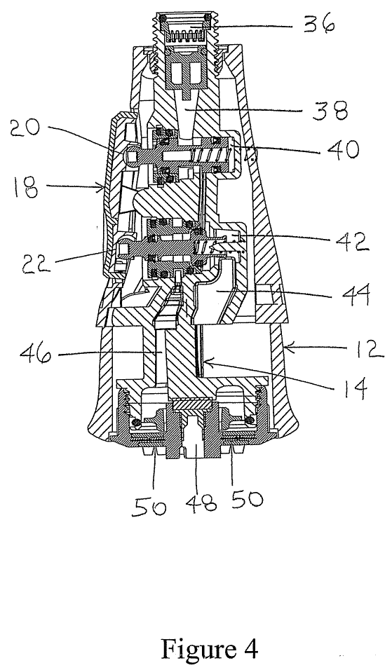

Referring to FIGS. 3 and 4, the waterway 14 includes an inlet 36, a first flow path 38, a first chamber 40, a second chamber 42, a second flow path 44, and a third flow path 46. In the embodiment shown in the Figures, the first chamber 40 is a flow chamber and the second chamber 42 is a diverter chamber. The inlet 36 is connected to a water supply. The inlet 36 is shown with threads for connection to the water supply. However, the inlet 36 could be connected to the water supply via other forms of connection. The flow valve 20 is disposed in the flow chamber 40. The diverter valve 22 is disposed in the diverter chamber 42. The spray face 16 includes a first outlet 48 and a second outlet 50. In the embodiment shown in the Figures, the first outlet 48 is a stream outlet and the second outlet 50 is a spray outlet.

The inlet 36 is fluidly connected to the first flow path 38. The flow chamber 40 is in the first flow path 38. The first flow path 38 is fluidly connected to the diverter chamber 42. The diverter chamber 42 is fluidly connected to both the second flow path 44 and the third flow path 46. The second flow path 44 is fluidly connected to the stream outlet 48. The third flow path 46 is fluidly connected to the spray outlet 50.

During operation, fluid flows into the wand 10 through the inlet 36. The fluid then flows into the first flow path 38. The flow valve 20 in the first flow path 38 controls the rate of fluid flow through the first flow path 38. The fluid then flows from the first flow path 38 into the diverter chamber 42. The diverter valve 22 in the diverter chamber 42 diverts the fluid flow from the first flow path 38 to either the second flow path 44 or the third flow path 46. The fluid then flows through the second flow path 44 and out the wand 10 through the stream outlet 48 or through the third flow path 46 and out the wand 10 through the spray outlet 50.

In one embodiment, the flow valve 20 moves between a first position extending partially out of the flow chamber 40 and a second position extending further or completely into the flow chamber 40. The flow valve 20 is spring-biased to a default mode. In the default mode, the flow valve 20 is in the first or outward position. The rate of fluid flow in the default mode is a low-flow. When the first end 32 of the button 18 is pressed, the flow valve 20 moves to an actuated mode. In the actuated mode, the flow valve 20 is in the second or inward position. Actuation of the flow valve 20 increases the rate of fluid flow through the first flow path 38 and, thus, through the wand 10. In one embodiment, the first end 32 of the button 18 must be continually pressed to maintain the flow valve 20 in the actuated mode. However, other embodiments are contemplated in which the flow valve 20 remains in the actuated mode without being continually pressed. The rate of fluid flow in the actuated mode is a high-flow. In one embodiment, the low-flow is at least ten percent (10%) less than the high-flow. In another embodiment, the low-flow is at least twenty-five percent (25%) less than the high-flow.

In one embodiment, the diverter valve 22 moves between a first position extending partially out of the diverter chamber 42 and a second position extending further or completely into the diverter chamber 42. The diverter valve 22 is spring-biased to a default mode. In the default mode, the diverter valve 22 is in the first or outward position. In one embodiment, the fluid flow from the wand 10 in the default mode is a stream. When the second end 34 of the button 18 is pressed, the diverter valve 22 moves to an actuated mode. In the actuated mode, the diverter valve 22 is in the second or inward position. In one embodiment, the fluid flow from the wand 10 in the actuated mode is a spray. Actuation of the diverter valve 22 diverts fluid flow from the second flow path 44 to the third flow path 46. In one embodiment, once the second end 34 of the button 18 is pressed, the diverter valve 22 is pressure-biased to the actuated mode until the flow valve 20 is actuated by pressing the first end 32 of the button 18 or the fluid flow to the wand 10 is discontinued. However, other embodiments are contemplated in which the diverter valve 22 remains in the actuated mode through other mechanisms.

In one embodiment, there are three possible combinations of modes for the flow valve 20 and the diverter valve 22 resulting in three possible combinations of modes for the wand 10. When the flow valve 20 is in the default/low-flow mode and the diverter valve 22 is in the default/stream mode, the wand 10 is in a low-flow stream mode. When the flow valve 20 is in the default/low-flow mode and the diverter valve 22 is in the actuated/spray mode, the wand 10 is in a low-flow spray mode. When the flow valve 20 is in the actuated/high-flow mode and the diverter valve 22 is in the default/stream mode, the wand 10 is in a high-flow stream mode. In this embodiment, since the flow valve 20 cannot be in the actuated/high-flow mode when the diverter valve 22 is in the actuated/spray mode, the wand 10 does not have a high-flow spray mode. However, other embodiments are contemplated in which the wand has a high-flow spray mode as well as multiple spray modes with various spray patterns.

In one embodiment, the low-flow spray is generally in the range of 1 gallon per minute to 1.2 gallons per minute, measured at a flowing pressure of 60 pounds per square inch. In one embodiment, the low-flow spray is more specifically approximately 1.1 gallons per minute, measured at a flowing pressure of 60 pounds per square inch. In one embodiment, the low-flow stream is generally in the range of 1.35 gallons per minute to 1.8 gallons per minute, measured at a flowing pressure of 60 pounds per square inch. In one embodiment, the low-flow stream is more specifically approximately 1.5 gallons per minute, measured at a flowing pressure of 60 pounds per square inch. In one embodiment, the high-flow stream is generally in the range of 1.8 gallons per minute to 2.2 gallons per minute, measured at a flowing pressure of 60 pounds per square inch. In one embodiment, the high-flow stream is more specifically approximately 2 gallons per minute, measured at a flowing pressure of 60 pounds per square inch.

During operation of the wand 10 in the low-flow stream mode (flow valve 20 in default mode/first position; diverter valve 22 in default mode/first position), water flows from the inlet 36 into the first flow path 38. The water then flows through the flow chamber 40 in the first flow path 38 in a low-flow mode. The water next flows through the diverter chamber 42 and is diverted to the second flow path 44. The water finally flows out the stream outlet 48 in a low-flow stream mode.

During operation of the wand 10 in the low-flow spray mode (flow valve 20 in default mode/first position; diverter valve 22 in actuated mode/second position), water flows from the inlet 36 into the first flow path 38. The water then flows through the flow chamber 40 in the first flow path 38 in a low-flow mode. The water next flows through the diverter chamber 42 and is diverted to the third flow path 46. The water finally flows out the spray outlet 50 in a low-flow spray mode.

During operation of the wand 10 in the high-flow stream mode (flow valve 20 in actuated mode/second position; diverter valve 22 in default mode/first position), water flows from the inlet 36 into the first flow path 38. The water then flows through the flow chamber 40 in the first flow path 38 in a high-flow mode. The water next flows through the diverter chamber 42 and is diverted to the second flow path 44. The water finally flows out the stream outlet 48 in a high-flow stream mode.

One of ordinary skill in the art will now appreciate that the present invention provides a low-flow wand including a flow valve that allows a low rate of fluid flow through the wand in a default mode and a high rate of fluid flow through the wand in an actuated mode. Although the present invention has been shown and described with reference to a particular embodiment, equivalent alterations and modifications will occur to those skill in the art upon reading and understanding this specification. The present invention includes all such equivalent alterations and modifications and is limited only by the scope of the following claims in light of their full scope of equivalents.

What is claimed is:

1. A wand, comprising:
a waterway including a flow path; and
a flow valve disposed in the flow path, the flow valve being operable to control a rate of fluid flow through the flow path;
wherein the flow valve allows a low rate of fluid flow in a default mode and a high rate of fluid flow in an actuated mode.

2. The wand of claim 1, wherein the flow valve must be continually actuated to maintain the flow valve in the actuated mode.

3. The wand of claim 1, wherein the flow valve is spring-biased to the default mode.

4. The wand of claim 1, wherein the low rate of fluid flow is at least ten percent less than the high rate of fluid flow.

5. The wand of claim 1, wherein the low rate of fluid flow is at least twenty-five percent less than the high rate of fluid flow.

6. The wand of claim 1, wherein:
the flow path includes a first flow path, a second flow path, and a third flow path.

7. The wand of claim 6, further including a diverter valve disposed between the first flow path and the second and third flow paths, the diverter valve being operable to divert fluid flow from the first flow path to the second flow path or the third flow path.

8. The wand of claim 7, wherein the diverter valve diverts fluid flow from the first flow path to the second flow path in a default mode and from the first flow path to the third flow path in an actuated mode.

9. The wand of claim 8, wherein the diverter valve is spring-biased to the default mode.

10. The wand of claim 8, further including a spray face, the spray face including a first outlet and a second outlet, wherein the second flow path is in fluid communication with the first outlet and the third flow path is in fluid communication with the second outlet.

11. The wand of claim 10, wherein:
when the flow valve is in the default mode and the diverter valve is in the default mode, fluid flows out the first outlet in a low-flow stream mode;
when the flow valve is in the default mode and the diverter valve is in the actuated mode, fluid flows out the second outlet in a low-flow spray mode; and
when the flow valve is in the actuated mode and the diverter valve is in the default mode, fluid flows out the first outlet in a high-flow stream mode.

12. A wand, comprising:
a waterway including an inlet and a plurality of flow paths; and
a spray face including a first outlet and a second outlet;
wherein the plurality of flow paths includes a first flow path in fluid communication with the inlet, a second flow path in fluid communication with the first flow path and the first outlet, and a third flow path in fluid communication with the first flow path and the second outlet;
a first valve disposed in the first flow path, the first valve being operable to control a rate of fluid flow through the waterway; and
a second valve disposed between the first flow path and the second and third flow paths, the second valve being operable to divert fluid flow from the first flow path to the second flow path or the third flow path;
wherein the first valve allows a low rate of fluid flow in a default mode and a high rate of fluid flow in an actuated mode.

13. The wand of claim 12, wherein the first valve must be continually actuated to maintain the first valve in the actuated mode.

14. The wand of claim 12, wherein the first valve is spring-biased to the default mode.

15. The wand of claim 12, wherein the low rate of fluid flow is at least ten percent less than the high rate of fluid flow.

16. The wand of claim 12, wherein the low rate of fluid flow is at least twenty-five percent less than the high rate of fluid flow.

17. The wand of claim 12, wherein the second valve diverts the fluid flow from the first flow path to the second flow path in a default mode and from the first flow path to the third flow path in an actuated mode.

18. The wand of claim 17, wherein the second valve is spring-biased to the default mode.

19. The wand of claim 17, wherein:
when the first valve is in the default mode and the second valve is in the default mode, fluid flows out the first outlet in a low-flow stream mode;
when the first valve is in the default mode and the second valve is in the actuated mode, fluid flows out the second outlet in a low-flow spray mode; and
when the first valve is in the actuated mode and the second valve is in the default mode, fluid flows out the first outlet in a high-flow stream mode.
